(19) United States
(12) Patent Application Publication
(10) Pub. No.: US 2022/0245416 A1
(43) Pub. Date: Aug. 4, 2022

(54) ITEM RETRIEVAL TAGS

(71) Applicant: CAROLYN ANN BERON, HILLSBORO, OR (US)

(72) Inventor: CAROLYN ANN BERON, HILLSBORO, OR (US)

(21) Appl. No.: 17/591,341

(22) Filed: Feb. 2, 2022

Related U.S. Application Data
(60) Provisional application No. 63/145,972, filed on Feb. 4, 2021.

(51) Int. Cl. G06K 19/06; G06K 19/04; G06F 16/9035; G06Q 20/10

(52) U.S. Cl. CPC G06K 19/06037; G06Q 20/108; G06F 16/9035; G06K 19/042

(57) ABSTRACT

The inventive concept is an item retrieval and return tag system and method with a monetary reward feature for the finder that includes has a retrieval member designed as a label or card member with an attachment mechanism included thereon. At least one machine-readable optical code member is disposed on an outer surface of the label or card member. The inventive concept includes a smart device optical scanner assembly. A computer processor assembly is operably connected to the smart device or smartphone optical scanner assembly. A database member is designed to retrieve owner contact or address information from the output of the smartphone optical scanner assembly. The machine-readable optical code member may be a bar code member, a QR code member, or other optical code.

This application claims priority to and the benefit of U.S. Provisional Application with Ser. No. 63/, filed on Feb. 4, 2021, with the same title, which is hereby incorporated by reference in its entirety.

### FIELD OF THE INVENTION

The inventive concept relates generally to an item retrieval tag system.

### BACKGROUND

Worldwide, thousands of items are left in airline terminals, on public transportation, or rental cars and turned into the lost and found departments of large companies daily. Police departments also recover thousands of items with little to no identifying information to be found on the lost item. The size of this problem, by way of statistics, is exhibited by the following: 12,000 laptops are lost weekly at airports; 120,000 phones are lost in taxi cabs annually, in Chicago alone; and 1.5 million bicycles are stolen with all of these items having about less than 5% chance of recovery.

The recovery rate however increases 80% when the finder of the lost item has a way to locate the owner. One example is there are microchips to locate lost pets. Another recovery solution attempts to use a name tag, but this solution is similarly unable to meet the needs of the market because name tags can be lost or removed and may invite unwanted attention or places the finder in an awkward position of trying to personally contact the owner, thereby disclosing their own confidential information or identity. Therefore, there currently exists a need in the market for an improved device and system that allows valuable items to be tagged and if found by individuals or law enforcement, to be returned to their rightful owners without a major effort on the part of the finder and with a high chance of being returned to the owner.

### SUMMARY OF THE INVENTION

The inventive concept is an item retrieval tag system, method and reward system for a finder that substantially increases the percentage of recover for an owner. The inventive concept enables people to return lost items to the rightful owners using an improved item retrieval tag system that have been previously attached to items of value.

One embodiment of the retrieval tag system and method has a label member with an adhesive inner surface portion. At least one machine-readable optical code member is disposed on an outer surface of the label member. The inventive concept includes a smartphone optical scanner assembly. A computer processor assembly is operably connected to the smartphone optical scanner assembly. A database member is designed to retrieve address information from the output of the smartphone optical scanner assembly. In one embodiment of the retrieval tag system the machine-readable optical code member is a bar code member. In one embodiment of the retrieval tag system the machine-readable optical code member is a QR code member.

One embodiment of the retrieval tag system and method has a card member with at least one machine-readable optical code member disposed on an outer surface of the card member. The inventive concept includes a smartphone optical scanner assembly. A computer processor assembly is operably connected to the smartphone optical scanner assembly. A database member is designed to retrieve address information from the output of the smartphone optical scanner assembly. In one embodiment of the retrieval tag system, the machine-readable optical code member is a bar code member. In one embodiment of the retrieval tag system, the machine-readable optical code member is a QR code member.

One embodiment of the retrieval tag system and method has a label member further comprising a durable, substantially planar polymer top member substantially contiguously overlaying a front surface of the label member. A substantially planar aluminum plate member substantially contiguously overlays a back surface of the label member by an interior side of the aluminum plate member, the aluminum plate member coupled to the polymer top member, the seal substantially watertight, the label member contained therein. An adhesive outer surface of the aluminum plate member is designed to be coupled to a surface. a smartphone optical scanner assembly. A computer processor assembly operably connected to the smartphone optical scanner assembly. A database member is designed to retrieve address information from the output of the smartphone optical scanner assembly. In one embodiment of the retrieval tag system, the machine-readable optical code member is a bar code member. In one embodiment of the retrieval tag system the machine-readable optical code member is a QR code member.

One embodiment of the retrieval tag system and method involves scanning with a smartphone optical scanner assembly at least one machine-readable optical code member, sending data from the smartphone optical scanner assembly to a computer processor assembly operably connected to the smartphone optical scanner assembly, and retrieving address information from a database member, the database member receiving the output of the smartphone optical scanner assembly. Address information may further include logistical instructions.

It would be advantageous to have a retrieval tag system that is smartphone compatible. Furthermore, it would be advantageous to have a retrieval tag system that is portable. Still further, it would be advantageous to have a retrieval tag system that employs adhesives.

The inventive concept may include an adhesive tag, pin on tag, or keychain tag. The inventive concept may be portable, reusable, and clip-on. The inventive concept may use human readable symbols as well as machine readable symbols.

The retrieval tag system advantageously fills the aforementioned deficiencies by providing an item retrieval tag, which provides a way to return lost possessions.

The retrieval tag system may include an item tracking tag.

The retrieval tag system may have a QR code.

The retrieval tag system may have adhesive tags.

The retrieval tag system fulfills the need for an item tracker.

Among other things, it is an advantage of the retrieval tag system to provide an item retrieval tag that does not suffer from any of the problems or deficiencies associated with prior solutions.

It is still further an advantage of the retrieval tag system to have a clip-on option or a pin-on option.

Still further, the retrieval tag system may have a keychain tag.

The inventive concept now will be described more fully hereinafter with reference to the accompanying drawings, which are intended to be read in conjunction with both this summary, the detailed description and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates a front view of a circular retrieval tag according to the teachings herein.

FIG. 2 illustrates a side view of the circular retrieval tag.

FIG. 3 illustrates a perspective view of the circular retrieval tag.

FIG. 4A illustrates a computer system that supports a retrieval tagging system.

FIG. 4B illustrates a control system which operates with the computer system to enable the retrieval tagging system.

FIG. 4C illustrates a node 601 that includes a network interface assembly configured to allow a control circuit assembly to receive and transmit information via a network.

FIG. 5 illustrates a smart device and smartphone optical scanner assembly and the retrieval tag system having a card member.

FIG. 6 illustrates the retrieval tag system that has a label member.

FIG. 7 illustrates the sealed label member.

FIG. 8 illustrates a method of retrieving registered property and rewarding a finder of the registered property.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

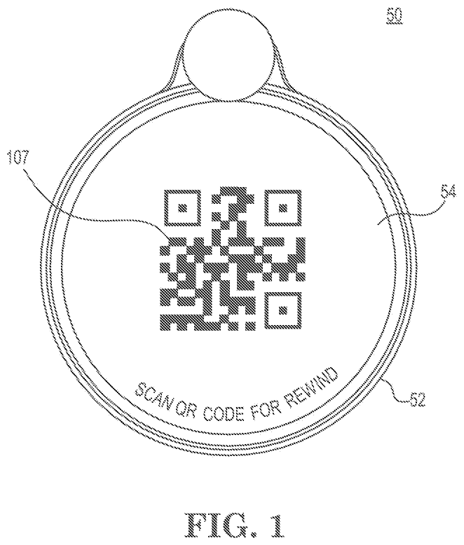

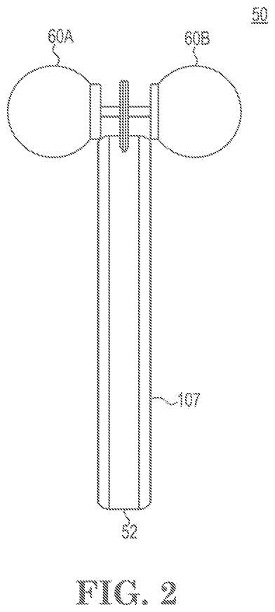

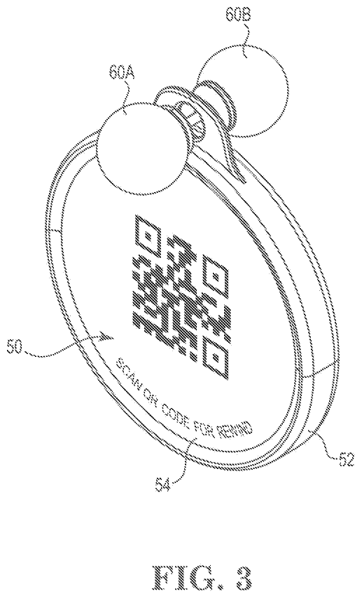

Referring to the figures, FIGS. 1-3 and 5-7 illustrate retrieval devices 10 that form part of an overall property retrieval system 600 to be further described herein. Examples of retrieval devices 10 include a circular retrieval tag member 50, a rectangular retrieval card member 100 and a label member 200 with information on one side (and adhesive on the backside), but are not limited to such form factors or shape. On the front end of the overall of personal property retrieval tag system 600, circular tag member 50 or card member 100 or label member 200 are adhered or attached to a personal property item to be tagged and retrieved when lost. In this example embodiment, tag member 50 and card member 100 include at least one machine-readable optical code member 105A or 105B, which can include a bar code 106 or a QR code 107. In the circular retrieval tag 50 a circular plate or disk 54 is secured within a ring-shaped holder 52, with tag 50 being attachable to the owner's property (such as car keys, a purse or an umbrella) using a separate side ring or a post pin 60A and ball 60B attachment device. One side of disk or plate 54 includes QR code 107 and the flipside of the plate or disk includes bar code 106.

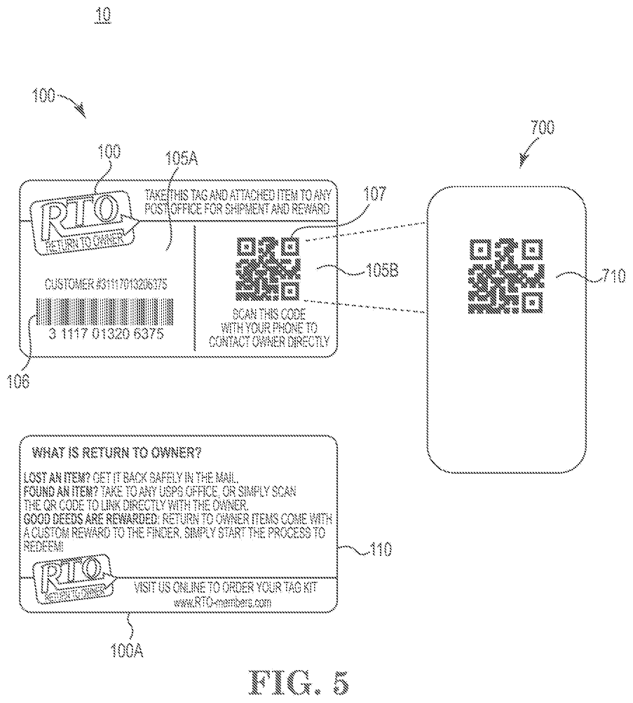

Referring to FIG. 5, in the card member 100 embodiment, bar code 106 and QR code 107 are on the same side, and on the flipside 100A or the back of card member 100, there is included a set of instructions 110 describing the steps for returning the lost property and making contact with the owner. Codes 106 and 107 are readable by optical scanning assembly 710 which is integrated into smart device or smartphone 700.

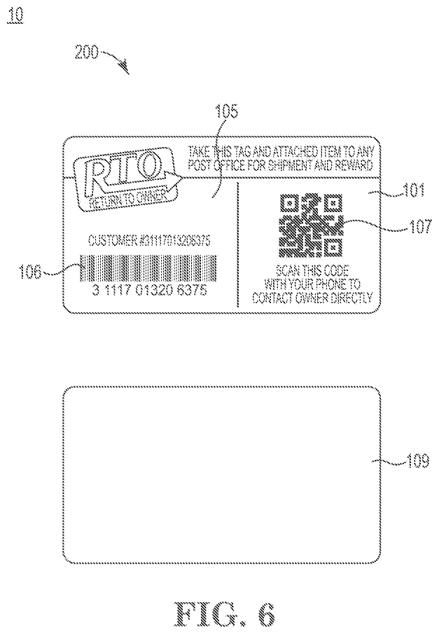

Referring to FIG. 6, in another embodiment of the retrieval tag system, the retrieval member 10 is configured as a label member 200 with a flipside 109 of the label member 200 having an adhesive and attaching inner surface 109A for attaching or adhering label member 200 to a property of the owner. At least one machine-readable optical code member 105, such as bar code 106 and QR code 107, is disposed on an outer surface of the label member 200. Attaching mechanisms include but are not limited to adhesives, hook and loop fasteners, snap button fasteners, and magnetic-type devices.

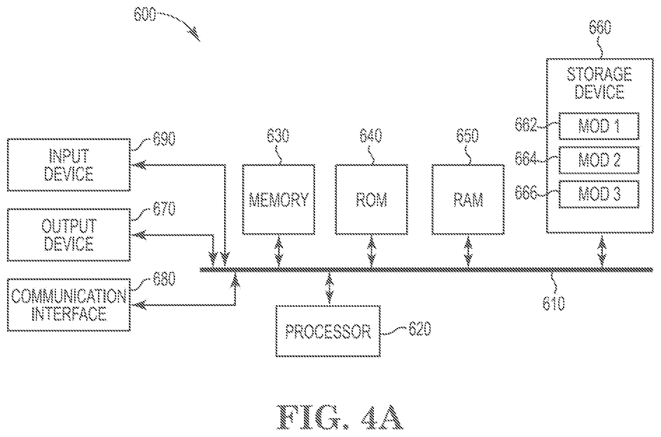

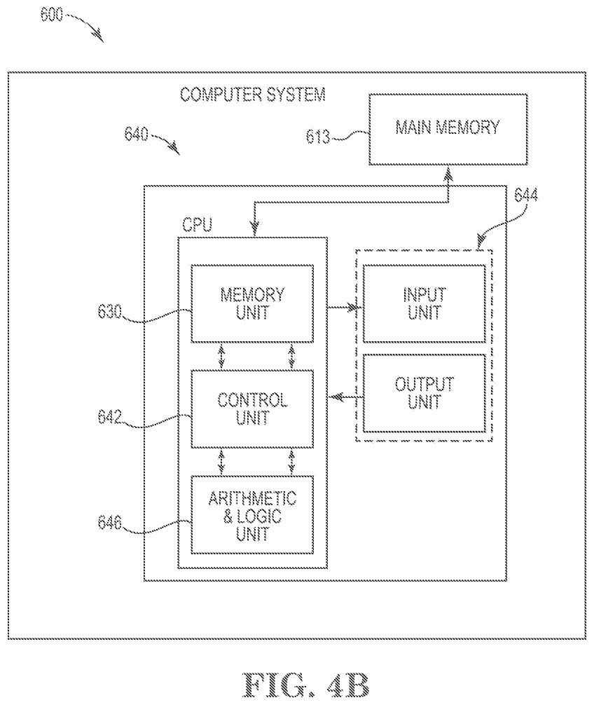

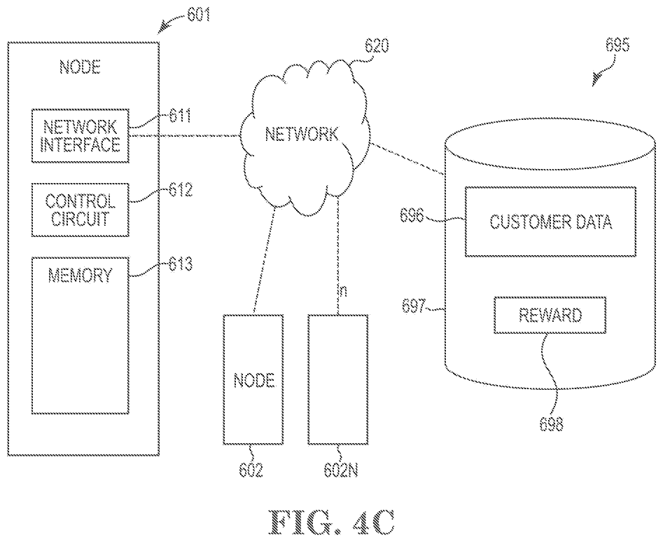

Referring to FIGS. 4A-4C and 5, item retrieval system 600 includes a smart device or smartphone 700 that further includes an optical scanner assembly 710 which is able to optically read both QR code 107 and bar code 106 (e.g., machine-readable optical codes) on the retrieval tag 10 used. With reference to FIG. 4B, system 600 includes a computer processor assembly 601 that is operably connected to the smartphone optical scanner assembly 710. With reference to FIG. 4C, a database member 695 is designed to retrieve address information from the output of the smartphone optical scanner assembly 710.

Referring to FIG. 5 and in a related embodiment of the retrieval tag system 600 there is included a card member 200 with at least one machine-readable optical code member 105 (such as QR code member 107 and bar code 106) disposed on an outer surface of the card member 201. The system includes a smartphone or smart device 700 having an optical scanner assembly 710. With reference to FIG. 4B, a computer processor assembly 600 is operably connected to the smartphone optical scanner assembly 700. With reference to FIG. 4C, a database member 695 is designed to retrieve address information from the output of the smartphone optical scanner assembly 700.

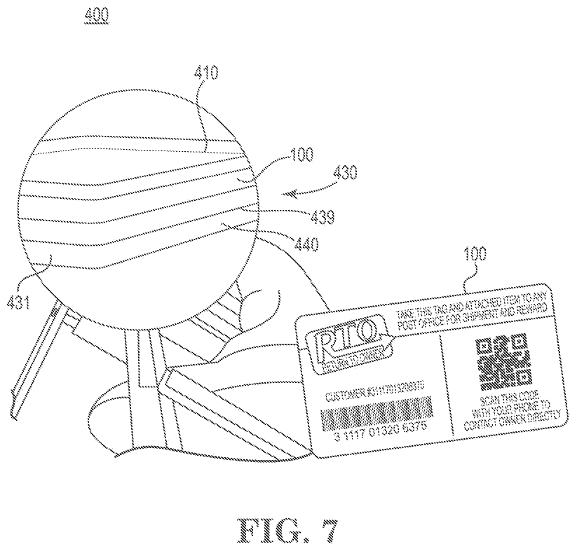

Referring to FIG. 7, one embodiment of the retrieval tag system 10 has a label member 400 further comprising a durable, substantially planar polymer top member 410 substantially contiguously overlaying a front surface of the label member 100. A substantially planar aluminum plate member 430 substantially contiguously overlays a back surface of the label member by an interior side of the aluminum plate member 439, the aluminum plate member 430 coupled to a polymer top member 410, the seal being substantially watertight, the label member 100 is contained therein. An adhesive outer surface of the aluminum plate member 431 is designed to be coupled to a surface. This embodiment of the inventive concept includes using a smart device or smartphone 700 with an integrated a smartphone optical scanner assembly 710. With reference to FIGS. 4B-4C, a computer processor assembly 600 operably connected to the smartphone optical scanner assembly 710 accesses network 620 and a database member 695 to facilitate connection with owner of retrieved property. Database member 695 in a memory module is designed to retrieve address information from the output of the smartphone optical scanner assembly 710. In one embodiment of the retrieval tag system, the machine-readable optical code member 105 includes bar code member 106 and QR code member 107.

Referring now to FIGS. 4A-4C and system 600 for processing owner information and connecting owner to finder of the lost property, FIG. 4A illustrates a computer bus assembly 610 that may be any of several types of bus structures used for receiving or transmitting data, control signals, and memory addresses from one component to another, including a memory bus or memory controller, a peripheral bus, and a local bus using any of a variety of bus architectures. A set of computer instructions controlling basic input and output system (BIOS) stored in ROM 640 or other such memory, may provide the basic routines that help to transfer information between elements within the computing system 600. The computing system 600 further includes one or more storage devices 660 such as a hard disk drive, a magnetic disk drive, an optical disk drive, a tape drive, or other storage medium for digital information. The storage device 660 can include software modules 662, 664, 666 for controlling the processor 620. Other hardware or software modules are considered. An interface drive connects the storage device 660 to the system bus 610. The drives and the associated computer-readable storage media provide non-volatile storage of computer-readable instructions, data structures, program modules, and other data for the computing system 600. In one aspect, a hardware module that performs a particular function includes the software component stored on a computer-readable storage medium in connection with the necessary hardware components, such as the processor 620, bus 610, display 670, and other elements, to carry out the function. In another aspect, the system can use a processor and tangible computer-readable storage medium to store instructions which, when executed by the processor, cause the processor to perform a method or other specified actions. The basic components and appropriate variations are contemplated depending on the type of the retrieval tag, such as whether the computing system 600 forms part of a small, handheld computing device 700, a desktop computer, a computer server, or other computerized device.

FIG. 4A, further illustrates that although the exemplary embodiment described herein utilizes storage device 660, which may include a hard drive or other types of computer-readable media that can store data and that are accessible by a computer, such as magnetic cassettes, flash memory cards, digital versatile disks, cartridges, random access memories (RAMs) 650, and read only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals.

FIG. 4A still further illustrates that to enable user interaction with the computing system 600 of smart device 700 having an input device 690 that represents any number of input mechanisms, such as keyboards, a mouse, scanners, digital cameras, joysticks, and microphones, touch-sensitive screens, light sticks, and other ways for a user to communicate information to the computing system 600 including, with reference to FIG. 5, a smartphone optical scanner 710. An output device 670 can also be one or more of a number of output mechanisms known to those of skill in the art, including but not limited to Visual Display Units (VDU) such as a monitor, printer, or graphical output device, or plotters, speakers, or speech synthesizers. In some instances, multimodal systems enable a user to provide multiple types of input to communicate with the computing system 600. A communications interface 680 generally governs and manages the user input and system output. There is no restriction on operating on any specific hardware arrangement, and, therefore, the features illustrated here may easily be substituted for improved hardware or firmware arrangements as hardware and firmware is developed.

With reference to FIG. 4B, a central processing unit (CPU) 640, also called a central processor or main processor, is the electronic circuitry within a computer system 600 that executes instructions that make up a computer program. The CPU 640 performs basic arithmetic, logic, controlling, and input/output (I/O) operations specified by the instructions in the program. An arithmetic & logic unit (ALU) 646 is a combination digital electronic circuit that performs arithmetic and bitwise operations in integer binary numbers. Traditionally, the term CPU 640 refers to a processor, more specifically to its processing unit and control unit (CU) 642, distinguishing these core elements of a computer from external components such as main memory 613 and input output (I/O) circuitry 644. A CPU 640 may also contain memory 630. Memory 630 refers to a component that is used to store information for immediate use in a computer 600.

FIG. 4C, further illustrates a node 601 (may include other nodes 602-602n) that includes a network interface assembly 611 which may have one or more network devices configured to allow the control circuit assembly to receive and transmit information via a network 620. In some embodiments, the network interface assembly 611 may have one or more of a network adapter, modem, a router, data port, and transceiver assembly. In some embodiments, the network 620 may include one or more of the Internet, a local area network, a private network, a virtual private network, a home network, a wired network, and a wireless network assembly. In some embodiments, the system 600 does not include a central server assembly and/or a trusted third-party system.

With reference to FIGS. 4B and 4C, a central processing unit (CPU) 640, also called a central processor or main processor, is the electronic circuitry within a computer 600 that executes instructions that make up a computer program. The CPU 640 performs basic arithmetic, logic, controlling, and input/output (I/O) operations specified by the instructions in the program. An arithmetic & logic unit (ALU) 646 is a combination digital electronic circuit that performs arithmetic and bitwise operations in integer binary numbers. Traditionally, the term CPU 640 refers to a processor, more specifically to its processing unit and control unit (CU) 642, distinguishing these core elements of a computer from external components such as main memory 613 and input output (I/O) circuitry 644. A CPU 640 may also contain memory 630. Memory 630 refers to a component that is used to store information for immediate use in a computer 600. System 600 further includes one or more databases 695 that may store customer information/data 696 and other data 697, as described herein inclusive of customer mail address and other contact information.

System 600 further includes a reward module 698 operatively coupled to or forming part of the database member 695, such that reward module 698 includes an inventory of an owner's property, associated values for each of the listed inventory items and includes associated rewards for each inventoried item. Associated rewards for each recovered item can be a fixed amount or a percentage of the value of the recovered item. In a related embodiment, the value of the inventoried item may drop automatically (at owner's request) on a monthly, quarterly or annual basis by a certain percentage to reflect current market value thereby reducing the recovery reward by a finder of the owner's property. Rewards for recovered items can be paid promptly using PayPal or Venmo to finder so as to incentivize prompt recovery. Rewards are also configurable to split into two parts: first payment upon connecting with the property owner and second payment with shipping confirmation is received by both the owner and the finder of the recovered property.

In yet another related embodiment, the machine-readable code 105 on retrieval tag 10 is replaced with a telephone number, an email address or website for logging on by the finder of the recovered property to connect with the owner.

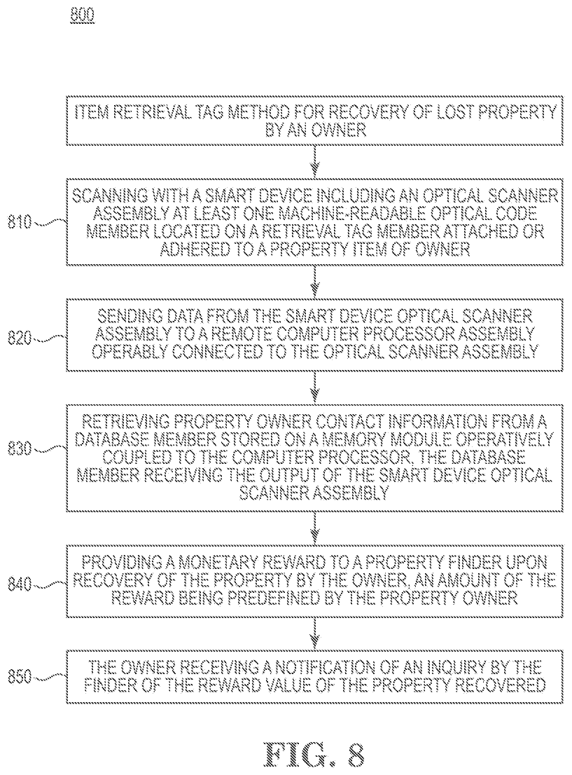

Referring now to FIG. 8, there is provided item retrieval tag method 800 for recovery of lost and registered property by an owner. Method 800 includes step 810 of scanning with a smart device including an optical scanner assembly at least one machine-readable optical code member located on a retrieval tag member attached or adhered to a registered property of owner. Step 820 includes sending data from the smart device optical scanner assembly to a remote computer processor assembly operably connected to the optical scanner assembly. Step 830 includes retrieving property owner contact information from a database member stored on a memory module operatively coupled to the computer processor, the database member receiving the output of the smart device optical scanner assembly. Further, step 840 includes providing a monetary reward to a property finder upon recovery of the registered property by the owner, an amount of the reward being predefined by the property owner. Step 850 of method 800 includes the owner receiving a notification of an inquiry by the finder of the reward value of the property recovered. The notification can be a text to the owner's cellphone or an email. Method 800 further includes the step of the owner registering one or more property items with a remote database, each property item being associated with the optical code member on the retrieval tag member to be adhered to the property item.

In related embodiments of method 800, the method includes rewarding the finder for the property upon the finder following recovery instructions and shipping the property, such that rewarding includes paying the finder via an electronic payment systems Venmo or PayPal. The method can also include setting the value of the reward as a percentage of an assigned value of a registered property or where the value of the registered property is configured to automatically decline any one of monthly, quarterly or annually timeframes consistent with parameters set by owner.

In another related method, the at least one machine-readable code is substitutable for owner contact information including a telephone number, an email address a website address. In yet another related method, method 800 includes rewarding the finder further includes the finder viewing the value of the reward of the property after scanning the machine-readable code on the retrieval tag member.

The following patents are incorporated by reference in their entireties: U.S. Pat. Nos. 7,341,186; 8,973,813; 10,043,152; 20150106292A1, and 20190325383A1.

While the inventive concept has been described above in terms of specific embodiments, it is to be understood that the inventive concept is not limited to these disclosed embodiments. Upon reading the teachings of this disclosure many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. An item retrieval tag system comprising:
a retrieval tag member with an adhering or attaching mechanism thereon adapted for adhering or attaching the retrieval tag member to a property item;
an at least one machine-readable optical code member disposed on an outer surface of the label member;
a smart device optical scanner assembly integrated with smart device, the optical scanner assembly adapted to read the at least one machine-readable optical code member;
a computer processor assembly operably connected to the smart device optical scanner assembly; and
a database member operatively coupled to the computer processor and adapted to retrieve property owner contact information from an output of the smart device optical scanner assembly.

2. The item retrieval tag system of claim 1 wherein the machine-readable optical code member is a bar code member.

3. The item retrieval tag system of claim 1 wherein the machine-readable optical code member is a QR code member.

4. An item retrieval tag system of claim 1 wherein the retrieval tag member is one of a group consisting of a circular tag or ring member, a card member and a label member.

5. The item retrieval tag of claim 1 wherein the attaching mechanism is one of a group consisting of adhesives, hook and loop fasteners, snap button fasteners, and magnetic-type devices.

6. The item retrieval tag of claim 4 wherein the owner contact information is one of a telephone number, an email address, a mailing address and a third party shipping or logistics vendor.

7. The item retrieval tag system of claim 4 wherein the label member further comprising a durable, substantially planar polymer top member substantially contiguously overlaying a front surface of the label member;
a substantially planar aluminum plate member substantially contiguously overlaying a back surface of the label member by an interior side of the aluminum plate member, the aluminum plate member coupled to the polymer top member, thereby forming a seal substantially watertight with the label member contained therein; and
an adhesive outer surface of the aluminum plate member adapted to be coupled to a surface.

8. The item retrieval tag of claim 1 wherein the database member is located in at least one server accessible via a network.

9. The item retrieval tag of claim 1 further comprising a reward module operatively coupled to the database member, wherein the reward module includes an inventory of an owner's property, associated values and associated rewards for each inventoried item.

10. An item retrieval tag method for recovery of lost property by an owner comprising:
scanning with a smart device including an optical scanner assembly at least one machine-readable optical code member located on a retrieval tag member attached or adhered to a registered property of owner;
sending data from the smart device optical scanner assembly to a remote computer processor assembly operably connected to the optical scanner assembly;
retrieving property owner contact information from a database member stored on a memory module operatively coupled to the computer processor, the database member receiving the output of the smart device optical scanner assembly; and
providing a monetary reward to a property finder upon recovery of the registered property by the owner, an amount of the reward being predefined by the property owner.

11. The item retrieval tag method of claim 10 wherein the database member further delivers logistical instructions for returning the lost property.

12. The item retrieval tag method of claim 10 further comprising the step of the owner registering one or more property items with a remote database, each property item being associated with the optical code member on the retrieval tag member to be adhered to the property item.

13. The item retrieval tag method of claim 12 wherein the at least one machine-readable optical code member is disposed or displayed on a circular or ring member, a card member or a label member.

14. The method of claim 10, further comprising rewarding the finder for the property upon the finder following recovery instructions and shipping the property, wherein rewarding includes paying the finder via an electronic payment systems Venmo or PayPal.

15. The method of claim 10, wherein the value of the reward is a percentage of an assigned value of a registered property.

16. The method of claim 15 wherein the value of the registered property is configured to automatically decline any one of monthly, quarterly or annually timeframes consistent with parameters set by owner.

17. The method of claim 10 wherein the at least one machine-readable code is substitutable for owner contact information including a telephone number, an email address a website address.

18. The method of claim 10, wherein the step of rewarding the finder further includes the finder viewing the value of the reward of the property after scanning the machine-readable code on the retrieval tag member.

19. The method of claim 18, further comprising the owner receiving a notification of an inquiry by the finder of the reward value of the property recovered.

20. The item retrieval tag method of claim 10 wherein the at least one machine-readable optical code member is disposed on a durable, substantially planar polymer top member substantially contiguously overlaying a front surface of the label member;
a substantially planar aluminum plate member substantially contiguously overlaying a back surface of the label member by an interior side of the aluminum plate member, the aluminum plate member coupled to the polymer top member, the seal substantially watertight, the label member contained therein, an adhesive outer surface of the aluminum plate member adapted to be coupled to a surface.
